(19) United States
(12) Patent Application Publication
(10) Pub. No.: US 2007/0013667 A1
(43) Pub. Date: Jan. 18, 2007

(54) Electronic device and method for entering characters therein

(76) Inventor: Tsun Yuen Chong, Yishun Emerald (SG)

Correspondence Address: MOTOROLA INC, 600 NORTH US HIGHWAY 45, ROOM AS437, LIBERTYVILLE, IL, 60048-5343, US

(21) Appl. No.: 11/179,367

(22) Filed: Jul. 12, 2005

(51) Int. Cl. G09G 5/00

(52) U.S. Cl. 345/173

(57) ABSTRACT

An electronic device (100) having a touch screen (106) and method (500) for entering data in into electronic device (100). The method performs displaying (502) in a character selection area (202) of the touch screen (106) a group of characters. Strokes that are scribed over the characters are detected (504) and inserted (506) and displayed in a character display area (204) of screen (504).

### FIELD OF THE INVENTION

The present invention relates generally to the field of electronic devices, and more specifically, electronic devices having touch screens that provide for entering characters.

### BACKGROUND

When electronic devices such as mobile phones, pagers, Personal Digital Assistants (PDAs), and so forth, were first developed, they typically had keypads for data entry. Over the past few years, several developments have taken place in the field of electronic devices. One such development has been a reduction in the size of electronic devices, resulting in the modification of existing data entry methods to suit the reduced size of the electronic devices. The emergence of touch screens for data entry is an example of such modifications.

One existing data entry method involves using a virtual keypad displayed on touch screens. The arrangement of the characters in existing virtual keypads typically corresponds to conventional QWERTY keypads. These keypads work efficiently in devices requiring two-hand operation, as in the case of typewriters and personal computers. However, entering characters on QWERTY keypads or other similar keypads is time consuming, especially when entering combinations of upper and lower case text.

### SUMMARY

According to one aspect of the invention, there is provided an electronic device comprising a processor and a touch screen operatively coupled to the processor, the touch screen having a character selection area displaying at least one group of characters and a character display area. In use, when a stroke has been scribed at least partially over a selected character from the of group of characters the processor automatically inserts a version of the selected character into the display area, the version of the character being dependent upon a scribed direction of the stroke.

According to another aspect of the invention, there is provided method of entering data in an electronic device. The method includes displaying at least one group of characters on a touch screen character selection area and detecting a stroke of a stylus on the touch screen character selection area, the stroke being at least partially scribed over at least one selected character from the group of characters. The method also includes inserting a version of the selected character, in a touch screen character display area of the device, wherein the version of the character is dependent upon a scribed direction of the stroke.

### BRIEF DESCRIPTION OF THE FIGURES

In order that the invention may be readily understood and put into practical effect, reference will now be made to an exemplary embodiment as illustrated with reference to the accompanying figures, where like reference numerals refer to identical or functionally similar elements throughout the separate views. The figures together with a detailed description below, are incorporated in and form part of the specification, and serve to further illustrate the embodiments and explain various principles and advantages, in accordance with the present invention where:

FIG. 1 is a schematic diagram illustrating an electronic device, in accordance with an embodiment of the present invention;

FIG. 2 is a view of a display region of a touch screen of the device of FIG. 1 when in operation;

FIG. 3 is another view of the display region of FIG. 2, illustrating how characters are entered into a character display area thereof;

FIG. 4 is a schematic diagram illustrating a grid co-ordinates for a character boundary associated with the display region of the touch screen of the device of FIG. 1; and

FIG. 5 is a flowchart illustrating a method for entering characters in the electronic device of FIG. 1.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

Various embodiments of the present invention provide an electronic device and a method for entering data in the electronic device. The electronic device includes a processor that is operatively coupled to a touch screen. The touch screen includes a character selection area displaying at least one group of characters, and a character display area displaying one or more selected characters. Characters are selected from the group of characters by stroking them with a stylus. The processor detects the stroke of the stylus and inserts a version of the selected characters into the character display area.

Before describing in detail embodiments that are in accordance with the present invention, it should be observed that the embodiments reside primarily in combinations of method steps and system components related to entering data in an electronic device. Accordingly, the system components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, the terms “comprises,” “comprising,” or any other variation thereof, are intended to cover a non-exclusive inclusion, such that a method, or device that comprises a list of elements does not include only those elements but may include other elements not expressly listed or inherent to such process, method, article, system or system. An element proceeded by “comprises . . . a” does not, without more constraints, preclude the existence of additional identical elements in the process, method, article, or system that comprises the element.

A “group” as used in this document, means a non-empty group (i.e., comprising at least one member). The term “another”, as used herein, is defined as at least a second or more. The terms “including” and/or “having”, as used herein, are defined as comprising. The term “program”, as used herein, is defined as a sequence of instructions designed for execution on a computer system. A “program”, or “computer program”, may include a subroutine, a function, a procedure, an object method, an object implementation, an executable application, an applet, a source code, an object code, a shared library/dynamic load library and/or other sequence of instructions designed for execution on a computer system.

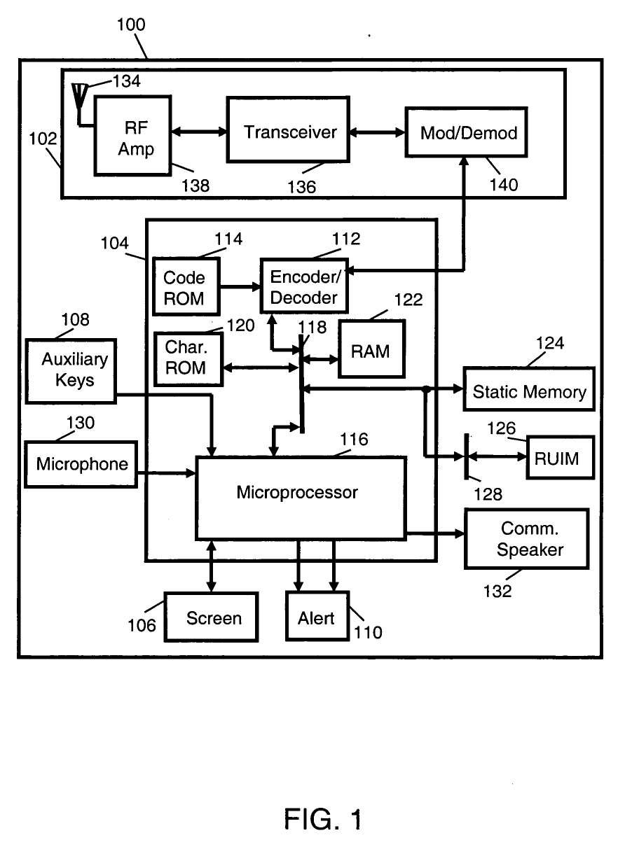

FIG. 1 is a schematic diagram illustrating an electronic device 100, in accordance with an embodiment of the present invention. The electronic device 100 is typically a wireless communications device, comprising a radio frequency communications unit 102 coupled to the processor 104 for the purpose of communication. Examples of the electronic device include a mobile phone, a laptop, a Personal Digital Assistant (PDA), and so forth. The electronic device 100 also has a touch screen 106 and auxiliary keys 108. There is also an alert module 110 that typically contains an alert speaker, a vibrator motor, and associated drivers. The touch screen 106, the auxiliary keys 108, and the alert module 110 are coupled to the processor 104 for the purpose of communication.

The processor 104 includes an encoder/decoder 112 with an associated code Read Only Memory (ROM) 114 for storing data, to encode and decode voice or other signals that may be transmitted or received by the electronic device 100. The processor 104 also includes a micro-processor 116 coupled, by a common data and address bus 118, to the encoder/decoder 112, a character Read Only Memory (ROM) 120, a Random Access Memory (RAM) 122, a static programmable memory 124, and a Removable User Identity Module (RUIM) interface 126. The static programmable memory 124 and a RUIM card 126 (commonly referred to as a Subscriber Identity Module (SIM) card) is operatively coupled to a RUIM interface 128, respectively. These can store, amongst other things, Preferred Roaming Lists (PRLs), subscriber authentication data, selected incoming text messages, and a Telephone Number Database (TND) phonebook containing a number field for telephone numbers and a name field for identifiers associated with one of the numbers in the name field. The RUIM card 126 and the static memory 124 may also store passwords to enable accessibility to password-protected functions on the electronic device 100.

The microprocessor 116 has ports for coupling to the touch screen 106, the auxiliary keys 108, and the alert module 110. The microprocessor 116 also has ports for coupling to a microphone 130 and a communications speaker 132 that are integral parts of the device.

The character Read Only Memory 120 stores a program or code for decoding or encoding text messages that may be received by the communications unit 102. In this embodiment, the character Read Only Memory 120, the RUIM card 126, and the static memory 124 may also store programs in the form of Operating Code (OC) for the microprocessor 116, and the code for performing functions associated with the electronic device 100.

The radio frequency communications unit 102 is a combined receiver and transmitter with a common antenna 134. The communications unit 102 has a transceiver 136 coupled to the antenna 134 via a radio frequency amplifier 138. The transceiver 136 is also coupled to a combined modulator/demodulator 140 that couples the communications unit 102 to the processor 104.

The touch screen 106 can be classified into three basic systems that are used to recognize a person's touch. Examples of the touch screen systems include resistive touch screens, capacitive touch screens, and surface acoustic-wave touch screens. The resistive touch screen uses an electrical current running through two layers, so that when a user touches the touch screen, the two layers make contact at that spot. The change in the electrical field is noted and coordinates of the point are calculated by using a computer. The capacitive touch screen includes a layer that stores an electrical charge. The layer is placed on the glass panel of a monitor. When a user touches the monitor, some of the charge is transferred to the user, and the charge on the capacitive layer decreases. Based on this decrease, a computer calculates the coordinates of the point where the touch event took place. In the surface-acoustic wave touch screen, a wave is set between the monitors by using transducers. When a user touches the touch screen, the wave pattern is disturbed, and this disturbance is used to locate the touch point.

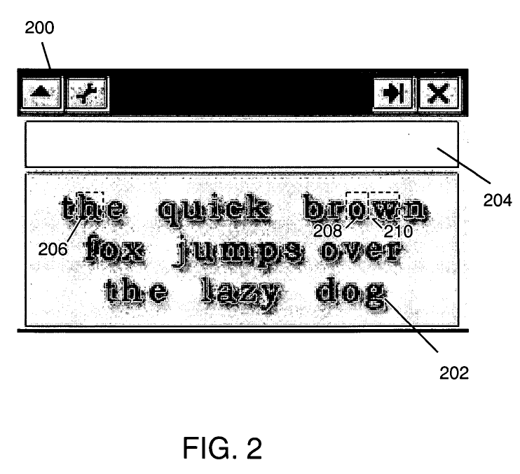

FIG. 2 is a view of a display region 200 of the touch screen 106, in accordance with an embodiment of the present invention. The display region 200 includes a character selection area 202 and a character display area 204. The character selection area 202 displays at least one group of characters. Examples of the group of characters include alphabets, numerals, and special characters. In an embodiment of the present invention, the group of characters typically includes a phrase with every letter of the alphabet. As shown in FIG. 2, the group of characters is in the form of the following well-known phrase ‘the quick brown fox jumps over the lazy dog’. This phrase (in all lower case characters) is a sentence known to include every one of the 26 letters (characters) of the alphabet. It should be appreciated that the group of characters is not limited to the English language. Characters from any other language can also be used, without departing from the scope of the invention. Each of the characters displayed has an associated character boundary three such character boundaries are illustrated, these being character boundary 206 for a character ‘h’, character boundary 208 for a character ‘o’ and character boundary 210 for a character ‘w’. It will be apparent to a person skilled in the art that these character boundaries need not necessarily be displayed in the display region 200 and are illustrated in this embodiment for explanation purposes. In use, one or more characters (letters) may be selected from the group of characters as described below. Further, the character display area 204 displays the selected characters, selected from the group of characters. The user may visually confirm the data displayed on the character display area 204, and register this data in the electronic device 100.

In an embodiment of the present invention, the processor 104 automatically inserts a version of the selected characters into the character display area 204, based on scribed directions of strokes scribed over the characters.

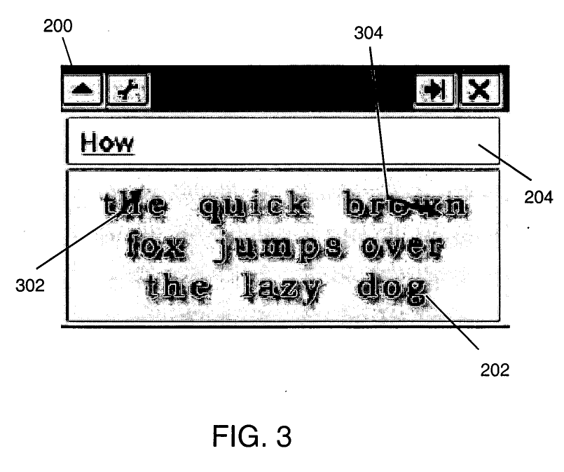

FIG. 3 is a view of the display region 200 illustrating how characters are entered into the character display area 204. One or more of the characters are selected from the group of characters in the character selection area 202 by stroking or scribing over characters desired to be entered into the character display area 204 with a stylus. For example, to enter ‘How’ in the electronic device 100, the stylus scribes a stroke in an ordered sequence at least partially over the characters ‘h’, ‘o’, and ‘w’. A stroke 302 represents the movement of the stylus over the character ‘h’, for the selection of the same. As illustrated, the stroke 302 is scribed over the character ‘h’ in an upwards direction, to enter it in upper case as ‘H’. A stroke 304 represents the movement of the stylus scribing over the characters ‘o’ and ‘w’. The single stroke 304 scribes over both the adjacent characters ‘o’ and ‘w’ in a left to right direct, to enter the characters ‘o’ and ‘w’ in lower case and to select the order of the characters as ‘ow’. However, if the order of the characters was required to be ‘wo’ then a single stroke could be scribed over both the adjacent characters ‘o’ and ‘w’ in a right to left direction. Similarly, other characters can be entered into the electronic device 100. It should be appreciated that the direction of the stroke (right to left or left to right) is relative to the direction in which characters are written according to the language that is used in the electronic device 100. Similarly, the upward and downward directions are relative to the orientation of the electronic device 100 and the display region 200.

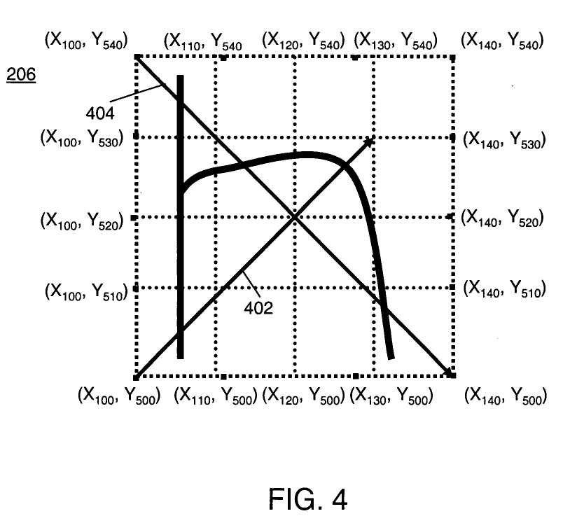

FIG. 4 is a schematic diagram illustrating grid co-ordinates for the character boundary 206 used by the touch screen 106. The character boundary 206 encompasses at least one character, in this example the character ‘h’. For the purpose of this description, the character boundary 206 is shown to include X and Y coordinates of various points and the X co-ordinates for the character boundary 206 are from 100 to 140 and the Y co-ordinates are from 500 to 540. The Y coordinates increase in a vertically upward direction, and the X coordinates increase in a horizontally right direction (left to right). In operation, while selecting the character ‘h’, the stylus scribes a stroke at least partially over this character, in other words the stylus scribes a stroke in the character boundary 206. Upon completion of this stroke the processor 104 automatically inserts a version of the selected character that is bounded by the character boundary into the character display area 204. The version of the character depends on the scribed direction of the stroke. The version of the character is case dependent and as previously stated, the character is inserted or entered in upper case when the stylus is stroked in an upwards direction at least partially over the character. Also, lower case characters are entered when the stylus is stroked in a direction other than upwards at least partially over the character. More specifically, the version of the character selected in a character boundary is determined by:
If Ystart−Yend>threshold_value 1 (test 1)

THEN an uppercase character displayed in the character boundary is selected; ELSE a lowercase character displayed in the character boundary is selected, where Ystart is the start Y co-ordinate of a scribed stroke in the character boundary and Yend is the end co-ordinate of the scribed stroke in the character boundary.

Typically, the value of the threshold_value 1 is approximately 10 and this value provides for eliminating or at least reducing some errors that may be caused by a user's unintentionally scribing an upward slanting stoke of a say 5 degrees that was actually meant to be scribed as a horizontal stroke. For example, stroke 402 starting at (X₁₀₀, Y₅₀₀) and ending at (X₁₃₀, Y₅₃₀), enters a character ‘H’ in the electronic device 100. Whereas a stroke 404, starting at (X₁₀₀, Y₅₄₀) and ending at (X₁₄₀, Y₅₀₀), enters a character ‘h’ in the character display area 204 of electronic device 100.

If the scribed stroke continues over a two adjacent characters such as ‘o’ and ‘w’ displayed in respective adjacent character boundaries 208, 210 then the order of selection as ‘ow’ or ‘wo’ is as described above. More specifically, the order of selection of adjacent characters selected by a single scribed stroke is determined by the order in which the stroke occurs, thus if the stroke is first scribed across the character boundary 208 and then character boundary 210 then ‘ow’ is selected. Alternatively, if the stroke is first scribed across the character boundary 210 and then character boundary 208 then ‘wo’ is selected. Furthermore, an upper case version of these character pairs is entered when Xstart−Yend>(2* threshold_value 1) and for a scribed stroke continuing over a three adjacent characters the upper case version of these character triplets is entered when Xstart−Yend>(3*threshold_value 1) and so forth.

In addition to the above, to account for a scribed accidental or careless overrun of a scribed stroke, a character is only selected if a scribed stroke comprises a minimum threshold length according to the following test:
|(Ystart−Yend)|+|(Xstart−Xend)|>threshold_value 2 (test 2)

THEN Character is in character boundary selected, where Xstart is the start X co-ordinate of a scribed stroke in the character boundary and Xend is the end co-ordinate of the scribed stroke in the character boundary, and where threshold_value 2 is the minimum number of pixels (Co-ordinate values) that comprise a scribe stroke. In this embodiment, since a character boundary is an array of 40 by 40 pixels (co-ordinates) then a reasonable value for the threshold_value 2 is 20.

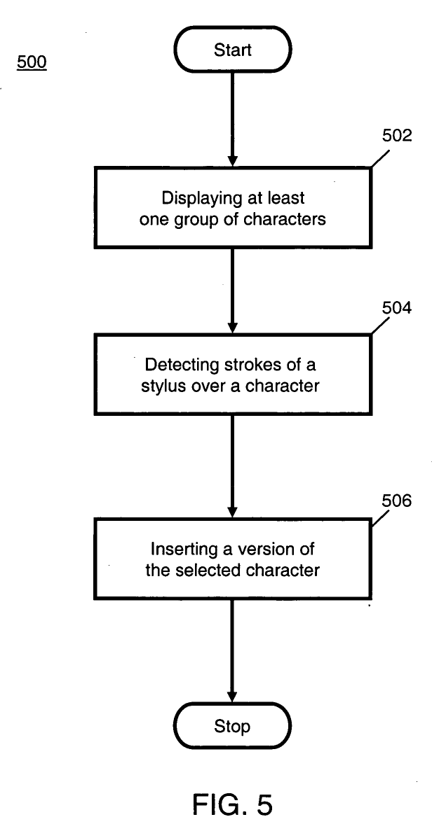

FIG. 5 is a flowchart illustrating a method 500 for entering characters in the electronic device 100. At block 502, at least one group of characters is displayed in the character selection area 202. At block 504, the processor 104 detects strokes of a stylus over a character or characters in the character selection area 202 while selecting a character from the group of characters

As described above, more than one character may be selected from the group of characters by scribing over adjacent character boundaries in a single stroke with the stylus. At block 506, the processor 104 inserts a version of the selected character in the character display area 204, after detecting the stroke of the stylus on the character in the character selection area 202. The selected characters are inserted into the device 100 (the character display area 204) in the same sequence or order as the scribed direction of the stylus.

The version of the selected character is dependent on the scribed direction of the stroke and the version of the selected one or more characters is case dependent and includes a version where all characters are capital letters or all the selected characters are in lower case or the first selected character in a sequence of characters is in upper case, with all other versions being in lower case. The version of the selected character and determining if a character has been selected is dependent upon test 1, test 2 and associated tests described above. However, in alternative embodiments the directions of the strokes could be changed such that upper case versions of a character or characters are selected only when the stylus is stroked in an downwards direction at least partially over the character or characters.

Advantageously, the present invention provides for selecting characters from a group of characters by strokes of the stylus across or insider character boundaries, for example character boundaries 206, 208, 210. Inserting and selecting the version of a character occurs when a stroke has been scribed at least partially over the plurality of selected characters from the group of characters, wherein the processor 104 automatically inserts versions of each of the selected characters into the character display area 204 upon completion of a scribed stroke. The sequence and case of the versions of the characters is dependent upon the scribed direction of the stroke thereby alleviating the requirement actuating a caps lock or shift key or other similar function in order to select between upper and lower case characters. Although, not specifically illustrated it will be appreciated that numbers, symbols and punctuations can also be entered in a similar fashion to that as described above or alternatively by conventional touch screen dedicated keys or conventional keypads. Also blanks and spaces can be entered by scribing over spaces in the phrase shown in FIG. 2 or alternatively by dedicated keys.

It will be appreciated that embodiments of the invention described herein may be comprised of one or more conventional processors and unique stored program instructions that control the one or more processors to implement, in conjunction with certain non-processor circuits, some, most, or all of the functions of the electronic device and method for entering data in the electronic device described herein. The non-processor circuits may include, but are not limited to, a radio receiver, a radio transmitter, signal drivers, clock circuits, power source circuits, and user input devices. As such, these functions may be interpreted as steps of a method to enter data in an electronic device. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

In the foregoing specification, a specific embodiment of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims.

We claim:

1. An electronic device comprising:
a processor; and
a touch screen operatively coupled to the processor, the touch screen having a character selection area displaying at least one group of characters and a character display area, wherein, in use, when a stroke has been scribed at least partially over a selected character from the of group of characters the processor automatically inserts a version of the selected character into the display area, the version of the character being dependent upon a scribed direction of the stroke.

2. An electronic device as claimed in claim 1, wherein when the stroke has been scribed at least partially over a plurality of selected characters from the of group of characters the processor automatically inserts versions of each of the selected characters into the display area, a sequence of the versions of the characters being dependent upon a scribed direction of the stroke.

3. An electronic device as claimed in claim 2, wherein the versions are case dependent from a group including: all characters being capital letters, all characters being lower case letters and the first letter in the sequence being capital letter with all other versions being lower case letters.

4. An electronic device as claimed in claim 1, wherein the version is case dependent.

5. An electronic device as claimed in claim 1, wherein at least one group of characters includes a phrase comprising every letter of the alphabet.

6. A method of entering data in an electronic device, the method including:
displaying at least one group of characters on a touch screen character selection area;
detecting a stroke of a stylus on the touch screen character selection area, the stroke being at least partially scribed over at least one selected character from the group of characters; and
inserting a version of the selected character, in a touch screen character display area of the device, wherein the version of the character is dependent upon a scribed direction of the stroke.

7. A method as claimed in claim 6, wherein inserting the version includes inserting a version of a plurality of selected characters when the stroke has been scribed at least partially over the plurality of selected characters from the at least one group of characters, wherein the selected characters are adjacent characters displayed in the character selection area.

8. A method as claimed in claim 7, wherein a sequence of the versions of the characters being dependent upon a scribed direction of the stroke.

9. A method as claimed in claim 6, wherein inserting a version includes inserting a case dependent version that is dependent upon a scribed direction of the stroke.

10. A method as claimed in claim 9, wherein inserting the case dependent version includes inserting from a group including: inserting a version where all characters being capital letters, inserting a version where all characters being lower case letters and inserting a version where the first letter in the sequence being capital letter with all other versions being lower case letters.
